(19) United States
(12) Patent Application Publication
(10) Pub. No.: US 2010/0238126 A1
(43) Pub. Date: Sep. 23, 2010

(54) PRESSURE-SENSITIVE CONTEXT MENUS

(75) Inventors: Liang Chen, Beijing (CN); David Patrick Vronay, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/408,740

(22) Filed: Mar. 23, 2009

(51) Int. Cl. G06F 3/041; G06F 3/048

(52) U.S. Cl. 345/173; 715/810

(57) ABSTRACT

Tools and techniques for pressure-sensitive context menus are provided. These tools receive indications of physical user activities directed to computing systems, and compute pressure parameters associated with the user activities. In turn, the tools may determine display characteristics of context menus that are presented in response to the user activity, based on the computed pressure parameters. The tools may also present the context menus on the computing systems.

### BACKGROUND

Traditionally, users interacted with computing systems by issuing commands using input devices such as keyboards, mice, and similar devices having various configurations. However, newer computing systems, for a variety of different reasons, may omit such traditional input devices, relying instead on touch-sensitive components to interact with users.

### SUMMARY

Tools and techniques for pressure-sensitive context menus are provided. These tools receive indications of physical user activities directed to computing systems, and compute pressure parameters associated with the user activities. In turn, the tools may determine display characteristics of context menus that are presented in response to the user activity, based on the computed pressure parameters. The tools may also present the context menus on the computing systems.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a combined block and flow diagram illustrating systems or operating environments suitable for pressure-sensitive context menus.

FIG. 2 is a block diagram illustrating additional features of an activity sensor and a pressure calculator, operable with the systems or operating environments for pressure-sensitive context menus, as shown in FIG. 1.

FIG. 3 is a flow chart illustrating process flows that may be performed in connection with the systems or operating environments that provide for pressure-sensitive context menus.

### DETAILED DESCRIPTION

The following detailed description provides tools and techniques for pressure-sensitive context menus. While the subject matter described herein presents a general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The following detailed description refers to the accompanying drawings that form a part hereof, and that show, by way of illustration, specific example implementations. Referring now to the drawings, in which like numerals represent like elements through the several figures, this description provides various tools and techniques related to pressure-sensitive context menus n.

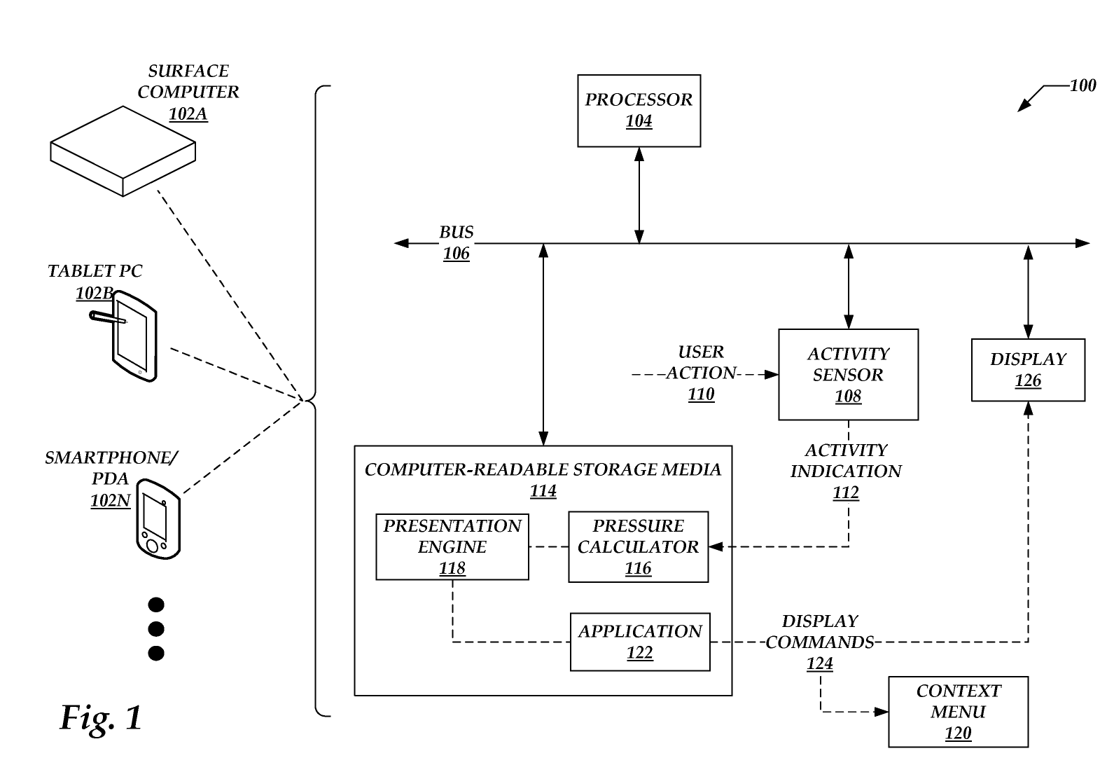

FIG. 1 illustrates systems or operating environments, denoted generally at 100, related to pressure-sensitive context menus. Turning to FIG. 1 in more detail, these systems 100 may support any number of computer systems, with FIG. 1 illustrating several non-limiting examples of such computer systems. More specifically, FIG. 1 illustrates a surface computer 102a, a tablet-based personal computer (PC) 102b, and a smart phone or wireless-enabled personal digital assistant (PDA) 102n. For ease of reference, but not to limit possible implementations of this description, this discussion refers to the surface computer 102a, the tablet PC 102b, and the smart phone 102n collectively as computing systems 102. It is noted that the graphical representations of the computing systems 102 are chosen only for convenience in presenting this description, but not to limit possible implementations of this description.

In general, the computing systems 102 may be responsive to non-linguistic physical actions performed by a given user (not shown in FIG. 1). These non-linguistic physical actions may be distinguished from verbal or spoken commands issued by the user, and may be further distinguished from interactions with visible representations of linguistic interfaces. For example, the surface computer 102a may generally respond to physical actions directed by the user to a physical substrate provided by the surface computer 102a. The tablet PC 102b and/or the smart phone 102n may include a stylus by which the user may interact with the tablet PC 102b and/or the smart phone 102n.

Turning to the computing systems 102 in more detail, these systems may include one or more instances of processing hardware, with FIG. 1 providing a processor 104 as an example of such processing hardware. The processors 104 may have a particular type or architecture, chosen as appropriate for particular implementations. In addition, the processors 104 may couple to one or more bus systems 106, having type and/or architecture that is chosen for compatibility with the processors 104.

The computing systems 102 may also include one or more activity sensors 108, coupled to communicate with the bus systems 106. The activity sensors 108 may take different forms, depending on the capabilities of different particular computing systems 102. For example, within the surface computer 102a, the activity sensors 108 may include optical systems that include cameras and other infrastructure suitable for detecting user actions directed to the surface computer 102a. Other examples of the activity sensors 108 may include touch-sensitive screens, panels, or displays, which respond to physical input from a stylus, a user's finger, or the like. In other implementation scenarios, the activity sensors 108 may be included within the stylus, such that the activity sensors 108 provide indications of a pressure exerted by the stylus against another physical object or surface.

In general, the activity sensor 108 may operate to detect physical actions 110 directed to the computing systems 102. In addition, the activity sensor 108 may generate signals 112 that represent or provide indications of the physical actions 110.

The computer systems 102 may include one or more instances of a physical computer-readable storage medium or media 114, which couple to the bus systems 106. The bus systems 106 may enable the processors 104 to read code and/or data to/from the computer-readable storage media 114. The media 114 may represent apparatus in the form of storage elements that are implemented using any suitable technology, including but not limited to semiconductors, magnetic materials, optics, or the like. The media 114 may represent memory components, whether characterized as RAM, ROM, flash, or other types of technology. The media 114 may also represent secondary storage, whether implemented as hard drives or otherwise. Hard drive implementations may be characterized as solid state, or may include rotating media storing magnetically-encoded information.

The storage media 114 may include one or more modules of software instructions that, when loaded into the processor 104 and executed, cause the computer systems 102 to provide pressure-sensitive context menus. As detailed throughout this description, these modules of instructions may also provide various tools or techniques by which the computing systems 102 may participate within the overall systems or operating environments 100 using the components, flows, and data structures discussed in more detail throughout this description. For example, the storage media 114 may include one or more software modules that implement the pressure-sensitive context menus.

In general, the software modules providing the pressure-sensitive context menus may, when loaded into the processors 104 and executed, transform the processors 104 and the overall computer systems 102 from general-purpose computing systems into special-purpose computing systems customized to provide pressure-sensitive context menus. The processors 104 may be constructed from any number of transistors or other discrete circuit elements, which may individually or collectively assume any number of states. More specifically, the processor 104 may operate as a finite-state machine, in response to executable instructions contained within the software modules stored on the media 114. These computer-executable instructions may transform the processors 104 by specifying how the processors 104 transition between states, thereby physically transforming the transistors or other discrete hardware elements constituting the processors 104.

Encoding the software modules providing the pressure-sensitive context menus may also transform the physical structure of the storage media 114. The specific transformation of physical structure may depend on various factors, in different implementations of this description. Examples of such factors may include, but are not limited to: the technology used to implement the storage media 114, whether the storage media 114 are characterized as primary or secondary storage, and the like. For example, if the storage media 114 are implemented as semiconductor-based memory, the software implementing the pressure-sensitive context menus may transform the physical state of the semiconductor memory, when the software is encoded therein. For example, the software may transform the state of transistors, capacitors, or other discrete circuit elements constituting the semiconductor memory.

As another example, the storage media 114 may be implemented using magnetic or optical technology. In such implementations, the software implementing the pressure-sensitive context menus may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

The storage media 114 may include one or more instances of a pressure calculator module 116, which may be implemented as one or more software components operable with the processors 104. More specifically, the pressure calculator module 116 may receive the activity indications 112 from the activity sensors 108. In turn, the pressure calculation module 116 may calculate or infer how much pressure is exerted by, or is associated with, the user action 110. For example, assuming that the computer systems 102 include a tablet PC 102b, the pressure calculator 116 may determine how “hard” a user is pressing a stylus against another surface. However, as detailed further below, other implementation scenarios are possible, without departing from the scope and spirit of the present description.

In some implementation scenarios, the activity indications 112 may directly specify to the pressure calculator 116 how much pressure is associated with the user actions 110. However, in other implementation scenarios, the activity indications 112 may indirectly specify how much pressure is associated with the user actions 110. In these latter scenarios, the pressure calculator 116 may infer how much pressure is associated with the user actions 110, based upon the indirect activity indications 112 provided by the activity sensor 108.

The storage media 114 may also include one or more modules providing a presentation engine 118. In general, the presentation engine 118 may operate to receive pressure parameters provided by the pressure calculator 116. In turn, the presentation engine 118 may modify some visual aspect of context menus 120 that are associated with one or more instances 122 of application software. In general, the application software 122 may represent any suitable application whose functionality is exposed to users of the computer systems 102.

Turning to the context menus 120 in more detail, the context menus 120 are distinguished from fixed menus provided by the application software 122. For example, fixed menus typically appear in the same location on a display screen each time the menus are presented. However, the context menus 122 may appear in different locations on the display screen, depending on where a given user action is directed to the display screen.

Examples of context menus may include relatively small menus presented in response to the user right-clicking a mouse or other user input device in the context of, for example, a word-processing application. However, previous implementations of context menus may obscure underlying content. Therefore, the present description provides various tools and techniques by which visible features of the context menus are varied in response to pressure associated with non-linguistic or physical actions 110 directed by users to the computing systems 102.

In implementations of the description herein, the presentation engine 118 may alter one or more visible features of the context menus 120 in response to signals from the pressure calculator 116. More specifically, the presentation engine 118 may cause the application software 122 to generate display commands 124 that incorporate the visible features on the context menus 120, as altered in response to pressure parameters associated with the user actions 110.

The computer systems 102 may include display hardware 126, which may respond to the display commands 124 to present output from the application software 122 in visible form to users of the computer systems 102. In addition, the display hardware 126 may also present the context menus 120, altered as described herein, in response to pressure parameters associated with the user actions 110.

For clarity of illustration, but not to limit possible implementations of this description, FIG. 1 represents certain signal and/or data flows with dashed arrows. Examples of the signal flows are denoted at 110, 112, and 124, as well as the dashed arrows appearing within the block 114. However, it is understood that signal and/or data flows represented by the dashed arrows 110, 112, and 124 may travel in any suitable direction along the bus systems 106. In addition, it is understood that signal and/or data flows represented by the dashed arrows within the block 114 may travel as appropriate internally within the processors 104. More specifically, these signal and/or data flows may occur within the processors 104 when the pressure calculator 116, the presentation engine 118, and/or the application software 122 are loaded into the processors 104 and executed.

For convenience only, FIG. 1 may illustrate some signal and/or data flows with unidirectional arrows. However, these unidirectional arrows as shown in FIG. 1 do not preclude implementations that include bidirectional signal and/or data flows.

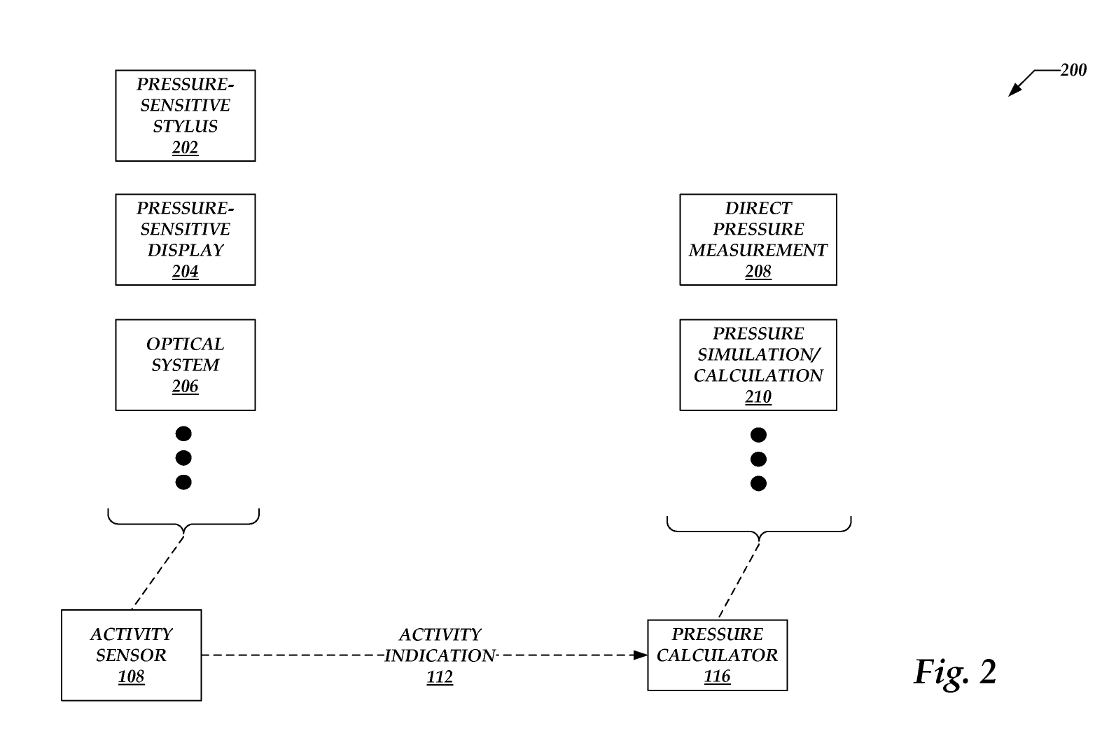

FIG. 2 illustrates additional features, denoted generally at 200, of the activity sensor and the pressure calculator modules. FIG. 2 carries forward from FIG. 1 examples of the activity sensor and the pressure calculator modules, denoted respectively at 108 and 116, for ease of reference. Without limiting implementations of this description, FIG. 2 may be understood as elaborating further on the activity sensor 108 and the pressure calculator 116, as well as the activity indications 112 shown in FIG. 1.

Turning to the activity sensor 108 in more detail, the activity sensor 108 may include any suitable hardware and/or software, recognized as appropriate in different implementations. For example, as represented at block 202, the activity sensor 108 may take the form of a pressure-sensitive stylus, operative to indicate a pressure with which the stylus is engaged against a surface. In addition, the computer systems 102 as shown in FIG. 1 may include or operate with the pressure-sensitive stylus 202.

As represented at 204, the activity sensor 108 may take the form of a pressure-sensitive display, operative to indicate a pressure with which a given user (not shown) is directing some physical action against the pressure-sensitive display. For example, the pressure-sensitive display 204 may represent touch-sensitive screens or displays that are responsive to physical contact initiated by the given user.

As represented generally at 206, the activity sensor 108 may take the form of an optical system that includes any number of cameras or other optically-sensitive devices, configured as appropriate to detect particular user actions (e.g., 110 in FIG. 1). For example, surface computers, such as those represented at 102a in FIG. 1, may include such optical systems to detect non-linguistic actions or physical contact directed to a computing surface. As described in further detail below, the pressure calculator 116 may infer a pressure associated with such non-linguistic actions.

Turning to the pressure calculator 116 in more detail, as represented generally at 208, the pressure calculator 116 may directly measure pressure as indicated by the activity sensor 108. For example, in scenarios in which the activity sensor 108 directly indicates a pressure by modulating an output signal, block 208 may represent receiving and measuring this modulated output signal to determine the pressure parameter associated with a given user action (e.g., 110 in FIG. 1).

As represented at block 210, the pressure calculator 116 may measure, simulate, or calculate pressure, in scenarios in which the activity sensor 108 does not directly indicate a pressure value associated with user actions (e.g., 110 in FIG. 1). Put differently, the pressure calculator 116 may infer or otherwise indirectly establish pressure values, in cases where the activity sensor 108 does not directly indicate these pressure values.

As a more specific example, referring to the optical system 206 shown in FIG. 2 as an example of the activity sensor 108, the optical system 206 may not directly measure pressure values associated with particular user actions. However, the optical system 206 may indicate factors related to a given physical action taken by a given user. Examples of such factors may include, but are not limited to, where the user has touched a surface, how long the user has touched the surface, and the like. Accordingly, the activity indications 112 as received by the pressure calculator 116 may include representations of such factors. In turn, the pressure calculator 116 may analyze these factors to simulate or project a pressure value associated with the given physical action. For example, processing represented by block 210 may include determining that if a given user touches the surface of a computing system (e.g., 102 in FIG. 1) for a relatively long time, then the pressure value associated with this touch may increase accordingly.

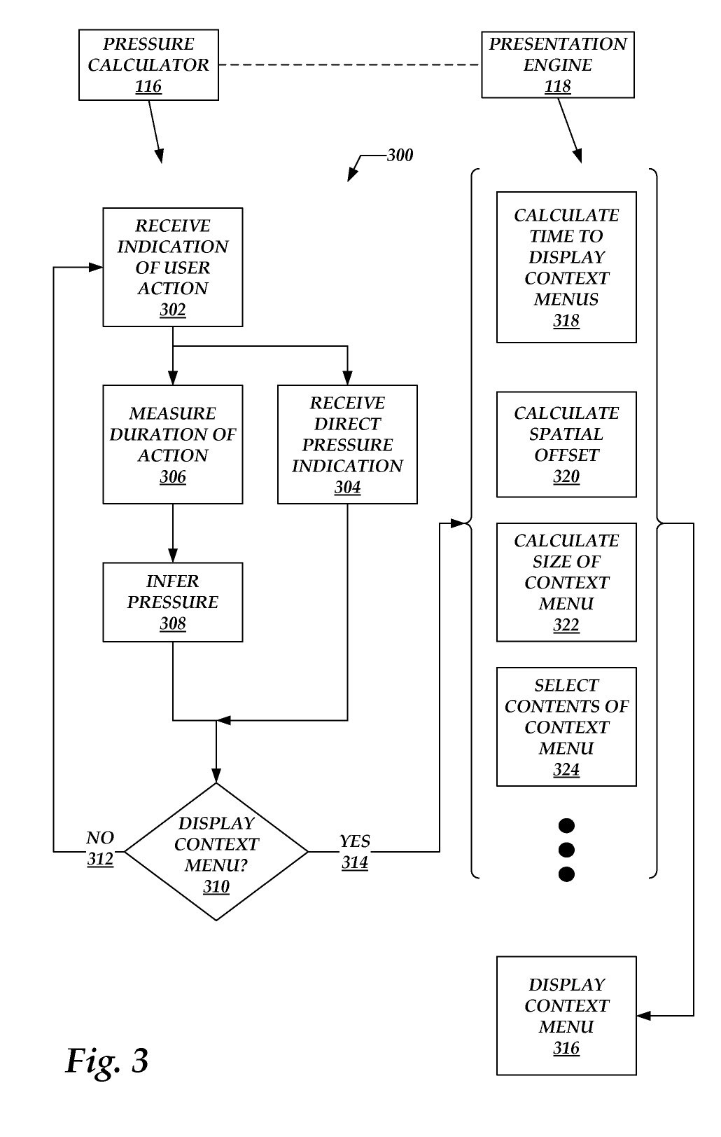

FIG. 3 illustrates process flows, denoted generally at 300, that may be performed in connection with the systems or operating environments that provide pressure-sensitive context menus. For ease of reference, but not to limit possible implementations of this description, FIG. 3 carries forward from FIG. 1 examples of the pressure calculator 116 and the presentation engine 118. For the purposes of the present description, the process flows 300 may be understood as elaborating further on illustrative processing performed by the pressure calculator 116 in cooperation with the presentation engine 118. However, it is noted that implementations of this description may perform at least portions of the process flows 300 using other components and modules, without departing from the scope and spirit of the present description.

Turning to the process flows 300 in more detail, block 302 represents receiving some indication of user action directed to one or more given computer systems. FIG. 1 provides examples of user actions at 110, with these user actions 110 generally including non-linguistic physical actions directed to particular computer systems (e.g., 102 in FIG. 1). As described above, the computer systems 102 may include activity sensors 108 adapted to detect the user actions, and to provide the indications received in block 302.

Block 304 represents receiving a direct indication of how much pressure is associated with the user action referenced in block 302. As described previously, some implementations of the activity sensors 108 may directly indicate how much pressure the users exert when performing the various user actions 110. In such scenarios, block 304 may include receiving indications of such pressure values.

In some implementations, the activity sensors 108 may not directly provide pressure values, but may provide other values from which the pressure calculator 116 may infer the pressure parameters. Accordingly, when direct pressure values are not available, the pressure calculator 116 may perform blocks 306 and 308 as an alternative to block 304, to infer or simulate indirectly the pressure values associated with a given user action.

As non-limiting examples of indirectly inferring pressure values, block 306 represents measuring a time duration or time interval associated with a given user action. In turn, block 308 represents inferring the pressure associated with a given user action. For example, user actions having longer durations may suggest higher pressure values, while user actions having shorter durations may suggest lower pressure values.

After performing either block 304 or blocks 306-308, the process flows 300 may proceed to decision block 310, which represents evaluating whether the pressure value associated with a given user action is sufficient to trigger display of a context menu. FIG. 1 provides an example of a context menu at 120. The pressure calculator 116 may implement one or more pressure thresholds, applicable to triggering display of the context menu. For example, these pressure thresholds may involve a given user performing a particular user action 110 for some period of time, or while exerting some level of pressure when performing a non-linguistic or physical action.

In some implementations, decision block 310 may involve evaluating whether the user actions 110 include occurrences of pre-defined pressure gestures, as recognized by the pressure calculator 116. By performing these pre-defined pressure gestures, the users may manifest requests to invoke the capabilities described herein for adjusting the display characteristics of context menus based on pressure values. Non-limiting examples of these pre-defined pressure gestures may include repeated circular motions performed in a given area on a user interface (UI) provided by the computer systems 102.

From decision block 310, if the pressure value associated with the given user action does not meet or exceed any applicable thresholds, the process flows 300 may take No branch 312 to return to block 302 to await indication of the next user action. However, returning to decision block 310, if the pressure value does meet or exceed at least one applicable threshold, the process flows 300 may take Yes branch 314 to display the context menu.

Block 316 represents displaying the context menu. However, the visible characteristics of the context menu may vary, depending upon the pressure value resulting from blocks 304-308. In this manner, the pressure calculator 116 in the presentation engine 118 may empower users to adjust the visible characteristics of the context menu by performing user actions with varying levels of pressure. Accordingly, before displaying the context menu in block 316, the process flows 300 may alter visible characteristics of the context menu. FIG. 3 provides several non-limiting examples of altering such visible characteristics, as now discussed in more detail.

Block 318 represents calculating a time duration or time interval over which the context menus are displayed, based on pressure values associated with user actions. For example, block 318 may include displaying context menus for a longer time in response to user actions associated with higher pressure values, and may include displaying the context menus for a shorter time in response to user actions associated with lower pressure values. However, implementations of this description may correlate pressure values and display times for the context menus in other ways, without departing from the scope and spirit of this description.

Block 320 represents calculating one or more spatial offsets associated with the context menus, based on pressure values associated with user actions. In general, spatial offsets as described herein refer to locations where context menus are presented on a display device in response to a given user action. More specifically, assuming that a given user action is associated with a given point or origin on the display device, block 320 may include spatially offsetting an origin of the context menu relative to this given point. For example, if a given user action is associated with a higher pressure value, this may indicate that the user wishes to have the context menu presented farther away from where the user performed that given action.

Conversely, if the given user action is associated with a lower pressure value, this may indicate that the user wishes to have the context menu presented closer to where the user performed the given action. However, implementations of this description may correlate pressure values and spatial offsets for the context menus in other ways without departing from the scope and spirit of this description. Put differently, this description may provide for correlating pressure values with distances at which the context menus are presented, relative to a point associated with a given physical action taken by the user.

Block 322 represents calculating a size or dimension associated with the context menu, based on the pressure values associated with particular user actions. For example, a given user action that is associated with a higher pressure value may indicate that the user is requesting a context menu of a larger size. Conversely, a given user action that is associated with a lower pressure value may indicate that the user is requesting a smaller context menu. However, implementations of this description may correlate pressure values and sizes of the context menus in other ways without departing from the scope and spirit of this description.

Block 324 represents selecting features for presentation in a context menu, based on the pressure values associated with particular user actions. For example, a given user action associated with a higher pressure value may indicate that the user is requesting a context menu containing representations of more features. Conversely, a given user action that is associated with a lower pressure value may indicate that the user is requesting a context menu that contains representations of fewer features. However, implementations of this description may correlate pressure values and features included in the context menus in other ways without departing from the scope and spirit of this description.

As appreciated from the foregoing description, blocks 318-324 provide various examples of how visible characteristics of the context menus may be responsive or sensitive to pressure factors or values associated with particular user actions. However, the examples represented in block 318-324 are provided only to facilitate the present description. Thus, implementations of this description may incorporate other examples of pressure-sensitive context menus without departing from the scope and spirit of the present description.

It is noted that the process flows 300 shown in FIG. 3 may be repeated indefinitely, to process any number of non-linguistic actions directed to any number of the computer systems 102. However, in the interests of clarity, FIG. 3 does not explicitly illustrate this repetitive processing.

The foregoing description provides technologies for pressure-sensitive context menus. Although this description incorporates language specific to computer structural features, methodological acts, and computer readable media, the scope of the appended claims is not necessarily limited to the specific features, acts, or media described herein. Rather, this description provides illustrative, rather than limiting, implementations. Moreover, these implementations may modify and change various aspects of this description without departing from the true spirit and scope of this description, which is set forth in the following claims.

We claim:

1. Apparatus comprising at least one physical computer-readable storage medium having stored thereon computer-executable instructions that, when loaded into at least one hardware processor and executed, transform the hardware processor to perform the following:
receive an indication of at least one instance of physical user activity directed to a computing system;
compute a pressure parameter associated with the user activity;
determine at least one display characteristic of a context menu presented in response to the user activity, based on the pressure parameter; and
display the context menu on the computing system.

2. The apparatus of claim 1, wherein the instructions to receive an indication include instructions to transform the hardware processor to receive an indication of user activity involving a stylus in interacting with the computing system.

3. The apparatus of claim 1, wherein the instructions to transform the hardware processor to receive an indication include instructions to receive an indication of user activity involving at least one predefined pressure gesture.

4. The apparatus of claim 1, wherein the instructions to compute a pressure parameter include instructions to transform the hardware processor to receive a pressure indication from a touch-sensitive component of the computing system.

5. The apparatus of claim 1, wherein the instructions to transform the hardware processor to compute a pressure parameter include instructions to infer the pressure parameter based on a duration of the user activity.

6. The apparatus of claim 1, wherein the instructions to transform the hardware processor to determine at least one display characteristic include instructions to calculate a time interval over which to display the context menu, based on the pressure parameter.

7. The apparatus of claim 1, wherein the instructions to determine at least one display characteristic include instructions to transform the hardware processor to calculate a spatial offset for displaying the context menu based on the pressure parameter, wherein the spatial offset specifies a distance between an origin associated with the user activity and an origin associated with the context menu.

8. The apparatus of claim 1, wherein the instructions to determine at least one display characteristic include instructions to transform the hardware processor to calculate a size of the context menu, based on the pressure parameter.

9. The apparatus of claim 1, wherein the instructions to determine at least one display characteristic include instructions to transform the hardware processor to determine contents of the context menu, based on the pressure parameter.

10. A computer-based system comprising:
at least one instance of processing hardware;
at least one activity sensor coupled to communicate with the processing hardware, and operative to generate signals indicating at least one instance of user activity directed to the system;
at least one bus system coupled to communicate with the processing hardware;
at least one computer-readable storage medium coupled to communicate with the processing hardware via the bus system, wherein the storage medium is encoded with computer-executable instructions that, when loaded into the processing hardware, transform the processing hardware to receive the signals, process the signals to determine a pressure parameter associated with the user activity, and to compute least one display characteristic of a context menu based on the pressure parameter; and
at least one display device operative to present the context menu to the user according to the display characteristic.

11. The system of claim 10, wherein the system is implemented in a surface computer, a tablet-based personal computer (PC), or a smart phone.

12. The system of claim 10, wherein the activity sensor is a pressure-sensitive stylus, a touch-sensitive display panel, or an optical system that employs a least one camera to identify the user activity.

13. The system of claim 10, wherein the instructions to compute the display characteristic include instructions to transform the hardware processor to calculate a time duration over which to present the context menu, based on the pressure parameter.

14. The system of claim 10, wherein the instructions to compute the display characteristic include instructions to compute at least one spatial offset at which to present the context menu, relative to an origin point associated with the user activity.

15. The system of claim 10, wherein the instructions to compute the display characteristic include instructions to calculate a size of the context menu, based on the pressure parameter.

16. The system of claim 10, wherein the instructions to compute the display characteristic include instructions to select at least one feature included within the context menu, based on the pressure parameter.

17. A computer-based system comprising:
at least one instance of processing hardware;
at least one activity sensor coupled to communicate with the processing hardware, and operative to generate signals indicating at least one instance of user activity directed to the system;
at least one bus system coupled to communicate with the processing hardware;
at least one display device coupled to communicate via the bus system, and operative to present a context menu to the user;
at least one computer-readable storage medium coupled to communicate with the processing hardware via the bus system, wherein the storage medium is encoded with computer-executable instructions that, when loaded into the processing hardware, transform the processing hardware to provide pressure-sensitive context menus, wherein the computer-executable instructions include
a pressure calculator module that is adapted to receive the signals indicating the user activity, and that is operative to generate output signals indicating a pressure value associated with the user activity;
a presentation engine module that is adapted to receive the output signals indicating the pressure value, that is operative to alter at least one visible characteristic of a context menu based on the pressure value, and that is adapted to generate display commands for presenting the context menu on the display device in response to the user activity.

18. The system of claim 17, wherein the storage medium includes at least one instance of application software, wherein the context menu is associated with the application software.

19. The system of claim 17, wherein the pressure calculator is operative to receive a direct indication of the pressure value from the activity sensor, or to infer the pressure value based on indirect indications of the pressure value as received from the activity sensor.

20. The system of claim 17, wherein the presentation engine is operative to:
calculate a time duration over which to present the context menu, based on the pressure value;
compute at least one spatial offset at which to present the context menu, relative to an origin point associated with the user activity, and based on the pressure value;
calculate a size of the context menu, based on the pressure value; or select at least one feature included within the context menu, based on the pressure value.
